(19) United States
(12) Patent Application Publication
(10) Pub. No.: US 2026/0298659 A1
(43) Pub. Date: Oct. 1, 2026

(54) METHOD FOR CREATING A DIGITAL ROAD MAP

(71) Applicant: Robert Bosch GmbH, Stuttgart (DE)

(72) Inventors: Alexander Bartler, Villingen-Schwenningen (DE); Annika Meyer, Karlsruhe (DE); Luca Zunino, Boeblingen (DE); Thomas Michalke, Weil Der Stadt (DE)

(21) Appl. No.: 19/572,258

(22) Filed: Mar. 19, 2026

(30) Foreign Application Priority Data
Mar. 25, 2025 (DE) 10 2025 111 449.8

(51) Int. Cl. G01C 21/00; G06N 3/08

(52) U.S. Cl. CPC G01C 21/3833; G01C 21/3807; G06N 3/08

(57) ABSTRACT

A method for creating a digital road map. The method includes: receiving environmental data which describe an environment of a motor vehicle; providing the environmental data to a vision large language model comprising a large language model; processing the environmental data using the vision large language model to ascertain a global language context prior about the environment; outputting the global language context prior using the vision large language model; and creating the digital road map based on the environmental data and based on the output global language context prior. A method for training an artificial neural network, a method for creating a digital road map, a device, a computer program, and a machine-readable storage medium, are also described.

### CROSS REFERENCE

The present application claims the benefit under 35 U.S.C. § 119 of Germany Patent Application No. DE 10 2025 111 449.8 filed on Mar. 25, 2025, which is expressly incorporated herein by reference in its entirety.

### FIELD

The present disclosure relates to methods for creating a digital road map, to a method for training an artificial neural network, to a device, to a computer program, and to a machine-readable storage medium.

### BACKGROUND INFORMATION

Digital road maps are an important component of autonomous driving systems, as they can, for example, provide precise and comprehensive information about the driving scene. For example, digital road maps include road elements such as pedestrian crossings, boundaries, traffic islands and center lines, and may also include the topological relationships between these elements.

### SUMMARY

An object of the present disclosure is to provide a concept for creating a digital road map.

An object of the present disclosure is also to provide a concept for training an artificial neural network based on which a digital road map can be created.

These objects may be achieved by certain features of the present disclosure. Advantageous example embodiments of the present disclosure are disclosed herein.

According to a first aspect of the present disclosure, a method for creating a digital road map is provided. According to an example embodiment, the method comprises the following steps:

Receiving environmental data which describe an environment of a motor vehicle,
providing the environmental data to a vision large language model comprising a large language model,
processing the environmental data using the vision large language model to ascertain a global language context prior about the environment,
outputting the global language context prior using the vision large language model, and
creating the digital road map based on the environmental data and based on the output global language context prior.

According to a second aspect of the present disclosure, a method for training an artificial neural network is provided. According to an example embodiment, the method comprises the following steps:

Receiving environmental data which describe an environment of a motor vehicle,
providing the environmental data to a vision large language model comprising a large language model and to the artificial neural network,
processing the environmental data using the vision large language model to ascertain a global language context prior about the environment,
outputting the global language context prior using the vision large language model,
wherein one epoch of training comprises the following steps:
   Processing the environmental data using the artificial neural network to ascertain at least one global context feature of the environment,
comparing the output global language context prior with the ascertained at least one global context feature,
adjusting at least one weight of the artificial neural network based on the comparison.

According to a third aspect of the present disclosure, a method for creating a digital road map is provided. According to an example embodiment, the method comprises the following steps:

Receiving environmental data which describe an environment of a motor vehicle,
providing the environmental data to an artificial neural network,
processing the environmental data using the artificial neural network to ascertain at least one global context feature of the environment and at least one feature of the environment,
outputting the ascertained at least one global context feature and the ascertained at least one feature using the artificial neural network,
creating the digital road map based on the output at least one global context feature and the output at least one feature,
wherein the artificial neural network was trained in accordance with the method according to the second aspect.

According to a fourth aspect of the present disclosure, a device is provided that is configured to perform all steps of the method according to the first aspect and/or according to the second aspect and/or according to the third aspect.

According to a fifth aspect of the present disclosure, a computer program is provided, comprising commands that, when the computer program is executed by a computer, for example by the device according to the fourth aspect, cause said computer to perform a method according to the first aspect and/or according to the second aspect and/or according to the third aspect.

According to a sixth aspect of the present disclosure, a machine-readable storage medium is provided, on which the computer program according to the fifth aspect is stored.

The present disclosure is based on and includes the finding that the above objects are achieved by using global language context prior about the environment, which the vision large language model ascertains as part of processing the environmental data, to create the digital road map. Using this global language context prior provides additional information for creating the digital road map.

This allows for creating a more accurate and reliable digital road map compared to conventional approaches to creating a digital road map.

Thus, an autonomous driving system for a motor vehicle can be operated efficiently and safely based on such a digital road map.

Using the global language context prior as an additional source of information for creating or generating a digital road map offers the following advantages, in particular:

The global language context prior provides global information at scene level to a map decoder for the purpose of creating the digital road map, so that the map decoder can summarize a spatially wide-ranging context more easily than with attention mechanisms at point or instance level.

Furthermore, using the global language context as an additional source of information has the following advantage: the global information contained in the global language context prior allows the map decoder to gain a broader understanding of the traffic scene. This applies even if the environmental data describe an environment that, for example due to detection problems, does not perfectly reflect the real environment, for example when the images taken by a camera or cameras of a motor vehicle are not entirely clear due to visibility or obscuration problems.

Another advantage is, for example, that the global language context prior can directly contain meaningful information about the topological relationships between traffic elements, so that, for example, it is no longer necessary to take the classical approach of linking together numerical representations of the potentially topologically related individual elements.

By using the large language model to train an artificial neural network in accordance with the method according to the second aspect, in particular the technical advantage is achieved that an accordingly trained artificial neural network can be used efficiently to create a digital road map. The training, as provided for in the method according to the second aspect, brings about in particular the technical advantage that, in the best case, the trained artificial neural network outputs a global context feature after training, which corresponds to global language context prior, such as that output by the vision large language model. In other words, the training brings about in particular the technical advantage that the artificial neural network behaves similarly, or ideally identically, to the vision large language model.

This means that, in accordance with the method according to the third aspect, the vision large language model is no longer needed to ascertain a global language context prior about the environment, on the basis of which the digital road map is created. Rather, in accordance with the method according to the third aspect it is provided for the artificial neural network trained in accordance with the method according to the second aspect to be used instead of the vision large language model in order to ascertain a global context feature of the environment, on the basis of which the digital road map is created. Using such an artificial neural network has, for example, the technical advantage that the additional information, i.e., in this case the global context feature, can be ascertained, for example, faster than the vision large language model ascertains the global language context prior. Thus, for example, the method according to the third aspect can be carried out faster than the method according to the first aspect. Thus, for example, the method according to the third aspect can be implemented in real time.

The vision large language model can be abbreviated as VLLM. The large language model can be abbreviated as LLM. LLM stands for a large AI (artificial intelligence) model that can process language and image information in combination.

Environmental data in terms of the description include, for example, one or more of the following data: radar data, ultrasonic data, infrared data, LiDAR data, image data, video data.

A digital road map in terms of the description is, for example, an HD road map. HD stands for high definition.

An artificial neural network in terms of the description is, for example, an image encoder that, in addition to its naive implementation, also attempts to map the features of the VLLM, i.e., to generate features with a high degree of context.

One example embodiment of the method according to the first aspect comprises the following steps:

Providing an input to the vision large language model, wherein the input includes a question about the motor vehicle's environment and/or a task to be performed based on the environmental data, processing the input and the environmental data using the vision large language model to output a text output corresponding to the input, wherein processing includes ascertaining at least one global feature and at least one token level feature using the large language model of the vision large language model, wherein the global language context prior is ascertained based on the at least one global feature and the at least one token level feature.

This results in a technical advantage, for example, that the global language context prior can be ascertained efficiently.

The token level feature is defined, for example, as follows: a low-dimensional feature that encodes individual words. Such a feature arises in the autoregressive process of the VLLM. Compound words of the speech output consist of multiple tokens. In particular, token level features are therefore low-dimensional features that encode individual words. They arise in the autoregressive process of the VLLM. Compound words consist of multiple tokens.

The global feature can be defined, for example, as follows: a higher-dimensional feature than a token level feature that describes an entire scene. A global feature is generated, in particular, once per signal input (environmental data, in particular image data, and meta-prompt). A global feature encodes, in particular, information from the environmental data, in particular image data, meta-prompt, and interpretation without a human-readable structure. Global features are therefore, in particular, higher-dimensional features than token level features that describe the entire scene. The global features are generated, in particular, once per signal input (environmental data, for example image data, and meta-prompt). Such features encode, in particular, information from the environmental data, in particular image data, meta-prompt, and interpretation encoded without a human-readable structure.

“Dimensionality” refers in particular to the following: the token level features, for example, have the form [1, N_channels], while the global features, for example, have the following form: [M, N_channels]. N_channels depends in particular on the model; for example, it is on the order of thousands (4096 for InternVL2.5, 2560 for DeepSeek-VL2). M depends, for example, on the environmental data, in particular the image data, prompt (an input in terms of the description, in particular speech and/or text input) and meta-prompt (the global prompt in terms of the description), and is therefore not fixed for a specific model; it can, for example, also be on the order of thousands (DeepSeek and InternVL are two VLLMs known to those skilled in the art).

The dimensionality of a token level feature is thus, for example, N_channels. The dimensionality of a global feature is thus, for example, (M times N_channels). Thus, “low-dimensional” means that N_channels is smaller than (M times N_channels). “Higher-dimensional” thus means that (M times N_channels) is greater than N_channels. A global feature is, in particular, a two-dimensional feature. A token level feature is, in particular, a one-dimensional feature.

An input (prompt) in terms of the description is, for example, a speech input or is, for example, a text input. For example, an input in terms of the description includes a text input and/or a speech input.

For example, it is provided for a speech input to be converted into a text input through text recognition. For example, converting the speech input into a text input through speech recognition can be done by an AI model external to the VLLM.

In one example embodiment of the method according to the first aspect, it is provided for the global language context prior to be checked for correctness and/or plausibility based on the text output, wherein the digital road map is created based on a result of the check.

This, for example, brings about the technical advantage that the digital road map can be created efficiently. In particular, this can bring about the technical advantage that the digital road map is reliable.

For example, it is provided for the creation of the digital road map to be omitted if the result of the check for correctness and/or plausibility is negative, i.e., if the global language context prior is not correct and/or not plausible, i.e., if it is incorrect and/or implausible.

In one example embodiment of the method according to the first aspect, it is provided for the vision large language model to be given a global prompt (also referred to as meta-prompt) indicating that the text output is to be used to create a digital road map.

This, for example, brings about the technical advantage that the text output can be created efficiently.

According to this example embodiment, it is thus provided that the global prompt (meta-prompt) gives the large language model a context, in this case that the text output is to be used to create the digital road map. The large language model thus knows that a digital road map, for example an HD map, is to be created.

In one example embodiment of the method according to the first aspect, it is provided for the environmental data to be processed by an artificial neural network in order to ascertain at least one feature of the environment, wherein the digital road map is created by a map decoder based on the at least one ascertained feature and the global language context prior.

This, for example, brings about the technical advantage that the digital road map can be created efficiently.

For example, the at least one ascertained feature is a so-called BEV feature, wherein BEV stands for “bird's eye view.” Thus, for example, environmental data include image data or video data from one or more cameras of a motor vehicle that capture the environment of the motor vehicle.

In one example embodiment of the method according to the first aspect, it is provided for at least one traffic rule and/or at least one digital SD road map and/or one digital pseudo-text SD road map to be provided to an embedding model for processing, wherein the digital road map is ascertained based on an output of the embedding model that is based on the processing.

This results in the technical advantage, for example, that the global language context prior can be created efficiently.

Thus, an additional source of information, in this case the embedding model, is available for ascertaining the global language context prior, so that, for example, a map decoder used for creating the digital road map can also be used to improve/refine the digital road map.

An embedding model is an approach to generate numerical values from text that can be interpreted by an AI model.

One example embodiment of the method according to the second aspect comprises the following steps:

Providing an input to the vision large language model, wherein the input includes a question about the motor vehicle's environment and/or a task to be performed based on the environmental data,

processing the input and the environmental data using the vision large language model to output a text output corresponding to the input, wherein processing includes ascertaining at least one global feature and at least one token level feature using the large language model of the vision large language model, wherein the global language context prior is ascertained based on the at least one global feature and the at least one token level feature.

In one example embodiment of the method according to the second aspect, it is provided for the global language context prior to be checked for correctness and/or plausibility based on the text output, wherein the artificial neural network is trained based on a result of the check.

This, for example, results in the technical advantage that the artificial neural network can be trained efficiently. The VLLM output (text output) is used, for example, during training to generate features containing global context prior using an image encoder. During inference (the actual application), VLLM and the corresponding prompts are no longer needed.

In one example embodiment of the method according to the second aspect, it is provided for the vision large language model to be given a global prompt indicating that the text output is to be used to create a digital road map.

In one example embodiment of the method according to the second aspect, it is provided for at least one traffic rule and/or at least one digital SD road map and/or one digital pseudo-text SD road map to be provided to an embedding model for processing, wherein the digital road map is ascertained based on an output of the embedding model that is based on the processing.

Statements made in connection with the method according to the first aspect apply analogously to embodiments in accordance with the method according to the second aspect and/or according to the third aspect and/or to the device according to the fourth aspect, and vice versa.

Technical functionalities and technical features of the method according to the first aspect result analogously from corresponding technical functionalities and technical features of the method according to the second aspect and/or the method according to the third aspect and/or the device according to the fourth aspect, and vice versa.

In general, method features thus result from device features, and vice versa. Method features of embodiments of the method according to the first aspect thus result analogously from corresponding method features of embodiments of the method according to the second aspect and/or the method according to the third aspect, or from device features of embodiments of the device according to the fourth aspect, and vice versa.

A method in terms of the description is, for example, a computer-implemented method.

The device is, for example, configured in terms of program technology to execute the computer program.

A method in terms of the description is carried out, for example, by means of the device.

The term “SD” stands for “standard.”

The embodiments and exemplary embodiments described here can be combined with one another in any way even if this is not explicitly described.

One example embodiment includes, for example, an embodiment of the method according to the second aspect and an embodiment of the method according to the third aspect.

The device according to the fourth aspect is, for example, comprised by a motor vehicle. Thus, for example, it may be provided for a method in terms of the description to be carried out, for example, on the motor vehicle side.

Thus, for example, the motor vehicle can, while driving, create a digital road map of the environment that it has already covered. Thus, for example, a motor vehicle creates, while driving, a digital road map of the environment that it has already covered.

For example, a method in terms of the description is carried out by a motor vehicle or on the motor vehicle side. For example, a method in terms of the description is carried out while a motor vehicle is driving.

A digital road map in terms of the description is, for example, a vectorized road map or is, for example, a rasterized road map.

The wording “at least one” means “one or more.”

A motor vehicle in terms of the description is, for example, an at least partially automated motor vehicle. The term “at least partially automated” includes: partially automated, highly automated, fully automated and autonomous.

Creating a digital road map in terms of the description includes, for example, creating a new digital road map and/or updating an existing digital road map.

The present disclosure is explained in more detail below using preferred exemplary embodiments.

### BRIEF DESCRIPTION OF THE DRAWINGS

FIG. 1 shows a flowchart of an example method according to the first aspect.

FIG. 2 shows a flowchart of an example method according to the second aspect.

FIG. 3 shows a flowchart of an example method according to the third aspect.

FIG. 4 shows an example device according to the fourth aspect.

FIG. 5 shows an example machine-readable storage medium according to the sixth aspect.

FIG. 6 shows an example block diagram describing an architecture of a vision large language model.

FIG. 7 shows an example block diagram describing the implementation of a vision large language model according to the concept described herein.

FIG. 8 shows a block diagram for explaining an example embodiment of the method according to the first aspect.

FIG. 9 shows a block diagram for exemplary explanation of an implementation of an embedding model according to the concept described herein.

FIG. 10 shows a block diagram for exemplary explanation of an embodiment of the method according to the second aspect.

FIG. 11 shows a block diagram for exemplary explanation of an implementation of an embodiment of the method according to the first aspect in a motor vehicle.

FIG. 12 is a block diagram for exemplary explanation of an implementation of an embodiment of a method according to the third aspect in a motor vehicle.

In the following, the same reference signs can be used for identical features.

### DETAILED DESCRIPTION OF EXAMPLE EMBODIMENTS

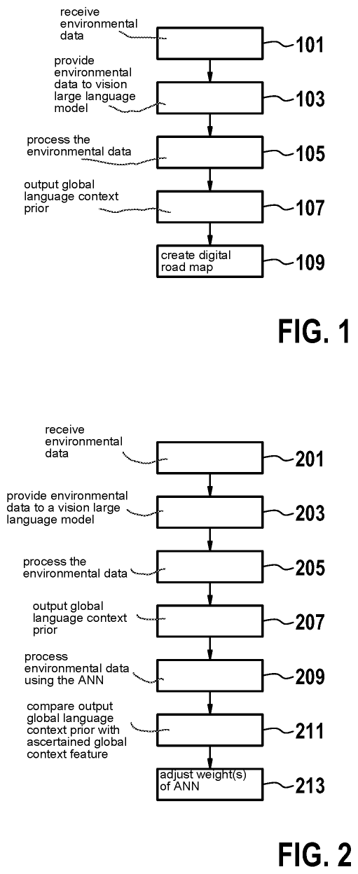

FIG. 1 shows a flowchart of a method for creating a digital road map, comprising the following steps:

Receiving 101 environmental data which describe an environment of a motor vehicle,
providing 103 the environmental data to a vision large language model comprising a large language model,
processing 105 the environmental data using the vision large language model to ascertain a global language context prior about the environment,
outputting 107 the global language context prior using the vision large language model, and
creating 109 the digital road map based on the environmental data and based on the output global language context prior.

Creating a digital road map in terms of the description includes, for example, creating a new digital road map and/or updating an existing digital road map.

FIG. 2 shows a flowchart of a method for training an artificial neural network, comprising the following steps:

Receiving 201 environmental data which describe an environment of a motor vehicle,
providing 203 the environmental data to a vision large language model comprising a large language model and to the artificial neural network,
processing 205 the environmental data using the vision large language model to ascertain a global language context prior about the environment,
outputting 207 the global language context prior using the vision large language model,
wherein one epoch of training comprises the following steps:
   Processing 209 the environmental data using the artificial neural network to ascertain at least one global context feature of the environment,
comparing 211 the output global language context prior with the ascertained at least one global context feature, adjusting 213 at least one weight of the artificial neural network based on the comparison.

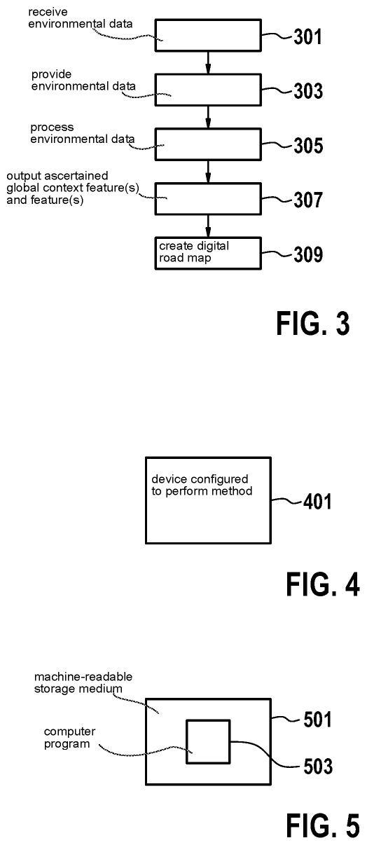

FIG. 3 shows a flowchart of a method for creating a digital road map, comprising the following steps:

Receiving 301 environmental data which describe an environment of a motor vehicle,
providing 303 the environmental data to an artificial neural network,
processing 305 the environmental data using the artificial neural network to ascertain at least one global context feature of the environment and at least one feature of the environment,
outputting 307 the ascertained at least one global context feature and the ascertained at least one feature using the artificial neural network,
creating 309 the digital road map based on the output at least one global context feature and the output at least one feature,
wherein the artificial neural network was trained in accordance with the method according to the second aspect.

FIG. 4 shows a device 401 that is configured to perform all steps of the method according to the first aspect and/or according to the second aspect and/or according to the third aspect.

FIG. 5 shows a machine-readable storage medium 501, on which a computer program 503 is stored. The computer program 503 comprises commands that, when the computer program 503 is executed by a computer, cause said computer to perform a method according to the first aspect and/or according to the second aspect and/or according to the third aspect.

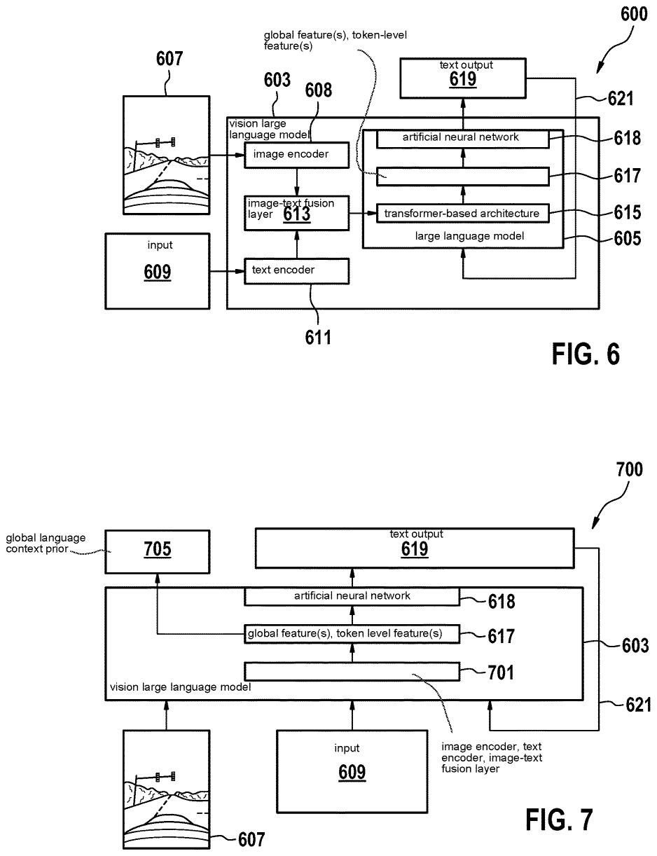

FIG. 6 shows a block diagram 600, which exemplifies an architecture of a vision large language model as it can be used for example according to the concept described here.

A vision large language model 603 is provided, which comprises a large language model 605.

The vision large language model 603 is provided with an image 607 of the environment of a motor vehicle. The image 607 is an example of environmental data in terms of the description.

The image 607, for example, was taken using a camera of the motor vehicle.

The vision large language model 603 is further provided with an input 609, which comprises a question about the environment of the motor vehicle and/or a task to be carried out based on the image 607. For example, the input 609 could read as follows: “What colors are the traffic lights in front of the motor vehicle?.”

The image 607 is processed by an image encoder 608 of the vision large language model 603 and the input 609 is processed by a text encoder 611 of the vision large language model 603 to ascertain an image-text fusion layer 613.

The image-text fusion layer 613 is hence a fusion of features of the image 607 and of the features of the text input 609. The fusion result from 613 is provided to the LLM 605. The LLM 605 processes the output of 613 to ascertain at least one global feature and at least one token level feature. This can be implemented, for example, by means of a transformer-based architecture according to a block 615.

The at least one global feature and the at least one token level feature are symbolically represented by a block with reference sign 617.

In the first autoregression run (see the statements below), the global feature arrives in high dimension as well as the first low-dimensional token level feature. Only one chain of token level features (i.e., encoded places) is then generated autoregressively.

Based on these features according to block 617, a text output 619 is generated by an artificial neural network 618.

The term head can also be used for the artificial neural network 618. Typically, the term head is used for artificial neural networks that are at the end of an AI chain and that generate a human-readable output (here a word from a token level feature).

The intention here is that the text output 619, which can also be referred to as output text, is generated token by token, i.e., autoregressively. Such autoregressive generation is symbolically indicated by an arrow with reference sign 621.

The text output 619 can, for example, include the following as a response to the input 609:“Both traffic lights in front of the motor vehicle are red.”

It should be noted here that the functionality of a VLLM 603 for generating information from an image and according to a text input is known as such. According to the concept described herein, the features according to block 617, i.e., the global feature and the token level feature, are used to ascertain a global language context prior, which is then used to create a digital road map.

FIG. 7 shows a block diagram 700, which illustrates the vision large language model 603 according to FIG. 6 in a simplified representation. The block 701 corresponds to the blocks 608, 611 and 613 according to FIG. 6.

The vision large language model 603 is provided with the image 607 of an environment of a motor vehicle, analogous to FIG. 6. According to the block diagram 700, the input 609 specifies the following: “Generate a global context as useful and complete as possible for the task yet to be performed of creating a digital road map.”

According to the concept described herein, the input 609 and the image 607 are processed by the vision large language model 603 to ascertain at least one global feature and at least one token level feature, exemplified by the block with reference sign 617.

Based on the features according to block 617, the global language context prior 705 is ascertained and output. For example, the global language context prior includes the at least one global feature and/or the at least one token level feature.

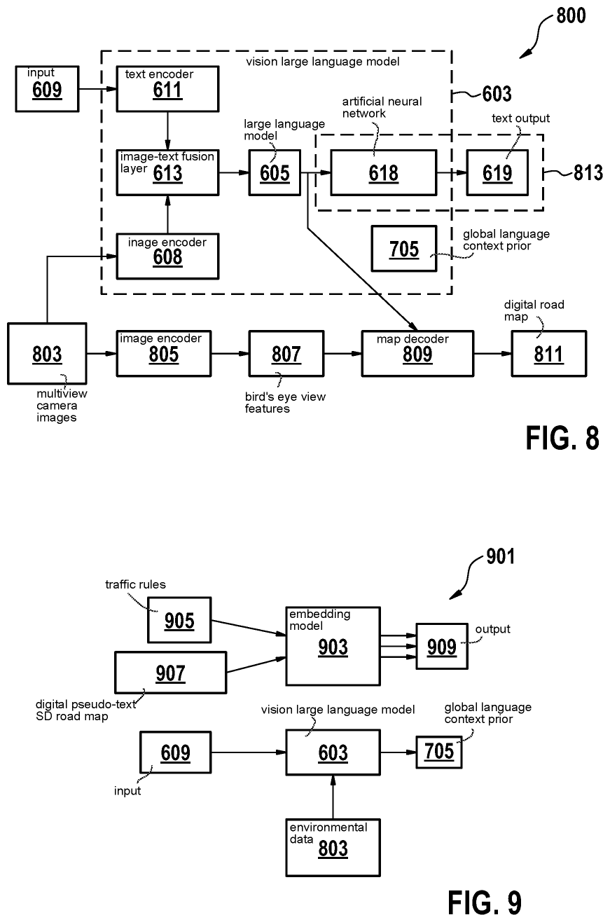

FIG. 8 shows a block diagram 800, which illustrates an exemplary embodiment of a method according to the first aspect. Using the vision large language model 603, as described above.

The environmental data provided to the vision large language model 603 are marked by a block with reference sign 803. According to the exemplary block diagram 800, these environmental data comprise multiview camera images. These are processed by the image encoder 609, as described above in connection with the image 607.

These multiview camera images 803 are then processed by a further image encoder 805 to obtain so-called “bird's eye view features,” i.e., features from a bird's-eye view, which are symbolically marked by a block with reference sign 807.

These features according to block 807 and the global language context prior 705 are provided to a map decoder 809, which creates a digital road map 811 based thereon, which can be, for example, a vectorized HD map.

The further image encoder 805 is, for example, an artificial neural network.

The text output 619 can optionally be used to check the global language context prior 705 for plausibility and/or correctness. The fact that this is optional is symbolically represented by a dashed block with reference sign 813.

FIG. 9 shows a block diagram 901, which illustrates by way of example the use of an embedding model 903 according to the concept described herein. For example, traffic rules 905 and/or a digital pseudo-text SD road map 907 are provided to the embedding model 903, wherein the embedding model processes these input data 905, 907 in order to output an output 909.

The output 909 comprises a result or output of the embedding algorithm, i.e., for example, a numerical representation of the module input (here, for example, a textual description of an SD map and traffic rules as text).

According to an exemplary embodiment, this output 909 together with the language context prior 705 can be used to create a digital road map.

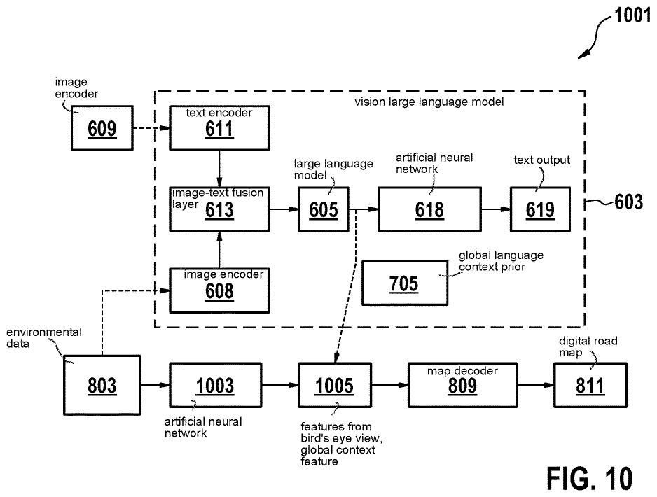

FIG. 10 shows a block diagram 1001 which exemplifies an exemplary embodiment of a method according to the second aspect and/or a method according to the third aspect using the vision large language model 603 as described above.

As part of the training, it is provided for the vision large language model 603 to output a global language context prior 705 based on the multiview camera images 803, as described above. The artificial neural network to be trained is indicated in the block diagram 1001 by a block with reference sign 1003. The artificial neural network is, for example, an image encoder. The artificial neural network 1003 processes the multiview camera images 803 and, according to the processing, ascertains a global context feature of the environment of the motor vehicle that has created the multiview camera images using its camera or cameras. One epoch of training includes the preceding step of processing the environmental data 803 using the artificial neural network 1003. One epoch of training further includes comparing the global language context prior 705 with the ascertained at least one global context feature. One epoch of training further includes adjusting at least one weight of the artificial neural network 1003 based on the comparison.

The goal of the training is for the artificial neural network 1003 to output a global context feature based on the environmental data 803, which is as similar as possible to the global language context prior 705. The goal is therefore for the artificial neural network 1003 to behave similarly to the vision large language model 603.

Once the artificial neural network 1003 has been sufficiently trained, it can be used in the context of interference to ascertain features from a bird's-eye view based on the multiview camera images 803, as well as to ascertain a global context feature, similar to how the vision large language model 603 would ascertain it.

These two features are symbolically represented in the block diagram 1001 by a block with reference sign 1005. These features according to the block 1005 are provided to the map decoder 809, which can create a digital road map 811 based thereon.

The vision large language model 603 is thus only used in the context of training, but not in the context of interference. Thus, interference can run faster, for example in real time, using only the artificial neural network 1003 and not the vision large language model 603.

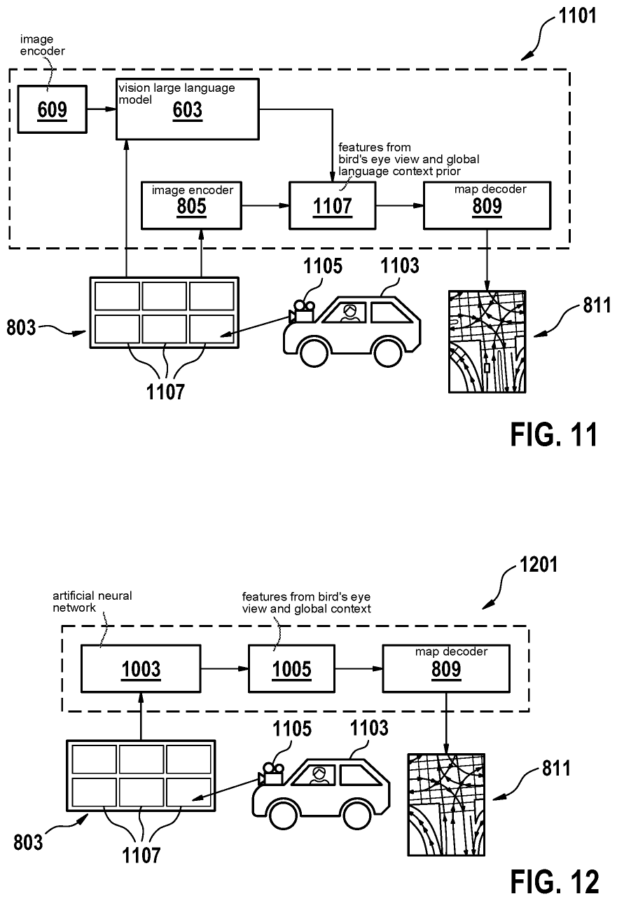

FIG. 11 shows a block diagram 1101, which illustrates an exemplary embodiment of a method according to the first aspect using the vision large language model 603, implemented in a motor vehicle 1103, which is, for example, an at least partially automated motor vehicle. The motor vehicle 1103 comprises, for example, one or more cameras, one of which is shown in FIG. 11 and is marked with reference sign 1105. The individual camera images of the multiview camera images 803 are symbolically represented by squares with reference sign 1107 within the block 803.

The features from the bird's-eye view and the global language context prior are summarized in the block diagram 1101 by a single block with reference sign 1107. The global language context prior is output by the vision large language model 603. The features from the bird's-eye view are output by the artificial neural network 805. Furthermore, reference is made to the explanations in connection with FIG. 8, where the process is described in more detail.

FIG. 12 shows a block diagram 1201, which illustrates an exemplary embodiment of a method according to the third aspect, implemented in a motor vehicle 1103 comprising one or more cameras 1105. To avoid repetition, reference is again made to what has been said in connection with FIG. 10. The artificial neural network 1003 is therefore an artificial neural network as trained in accordance with the method according to the second aspect.

The following describes exemplary embodiments or implementations of methods according to the first aspect, the method according to the second aspect, and the method according to the third aspect.

In particular, it is provided for using a global language context prior created by a VLLM as an additional source of information for an online HD map generation model. This language context prior can be ascertained by the VLLM, for example, as follows.

Each of the multiview images captured by the cameras of an ego motor vehicle is forwarded to a VLLM along with a prompt describing the desired task (e.g., “Create a global context that is as useful and complete as possible for the subsequent task of HD map creation”).

The VLLM generates a series of “global” and “token level” features, which are then forwarded to the language head (neural network) of the LLM and produce an output text (e.g. “The image shows a scene from the perspective of the windshield of a car looking towards an empty highway”).

The “global” and “token level” feature (vectors) are aggregated, for example, to ascertain the global language context prior. The feature vectors generated by the LLM before the language head are much more informative than the generated output text. This is why it is provided to use the feature vectors as global language context prior, and the output text can be used, for example, for verification purposes.

The global language context prior is forwarded in particular as an additional input to an online HD map generation model, which can use the additional information to refine the generated map. More precisely, a cross-attention mechanism is used, for example, in the image encoder module or in the map decoder module of the map generation system, so that the BEV (bird's-eye view) features extracted by the image encoder can interact with the global language context prior.

For example, using the global language context prior as an additional source of information for the online HD map generation model offers several advantages over the prior art.

The global language context prior can provide the map decoder with global information (at scene level), allowing it to summarize a broader context more easily than with attention mechanisms at point or instance level.

The global information contained in the global language context prior can enable the map decoder to obtain a more comprehensive picture of the traffic scene, even if the images captured by the ego motor vehicle's camera(s) are not entirely clear due to visibility or obstruction problems.

The global language context prior can contain meaningful information about the topological relationships between the traffic elements in the map, so that it is no longer necessary to consider the linked elements of the individual elements in order to derive such relationships.

One exemplary extension involves using traffic rules, common sense knowledge, and SD map data to create the digital road map (keyword: embedding model). In this way, an additional source of information can be created that can be used by the map decoder to improve and refine the generated HD map.

The text output generated by the LLM's language head can make it possible to pre-check the global language context prior, control the effectiveness of the approach, and make the entire pipeline more interpretable and robust.

In particular, two main strategies are provided for the implementation of the proposed concept, one of which (“method according to the third aspect”) has the potential to run in real time on a motor vehicle and to be used in production systems. The method according to the first aspect can be described as a “naive” implementation. The method according to the third aspect can be described as a real-time-capable implementation.

An implementation of an online HD map generation model that uses a global language context prior generated by a VLLM is shown in FIG. 8 and has been explained above. The most important steps of the pipeline are described again below.

The multiview images captured by the cameras of the ego motor vehicle are provided to a VLLM along with a text prompt specifying the desired task (creating a context to support the downstream task of HD map creation).

The text and image embeddings generated by the respective encoders are fused and forwarded to the LLM within the VLLM, which generates “global” and “token level” feature (vectors) that are processed to obtain a global language context prior.

Optionally, the LLM's language head can be used to obtain a textual output that corresponds to the generated global language context prior. The textual output can be used for verification purposes, but is not used directly by the online HD map generation model, for example.

The multiview camera images are also forwarded to an image encoder, which generates a series of BEV features. This part of the pipeline is standard and has already been described several times in the literature.

The BEV features and the global language context prior are forwarded to the map decoder, which combines the two sources of information (using cross-attention or similar mechanisms) and generates a vectorized HD map as output.

For example, to save time and computing resources, it may be provided not to send every image or frame to the VLLM. For example, it may be provided to provide only every nth image to the VLLM, where n>1. Since the traffic scene usually changes very little between successive frames or images, the differences between the nth images should not be too great. This means that the global language context prior does not need to be updated with every new input frame.

For example, the following effective and simple implementation strategy could be provided for, in which the VLLM is used only during training and not at the time of inference. More precisely, it may be sufficient to introduce a new set of features (in addition to the BEV features) and compare them with the features generated by the VLLM during training. The revised pipeline is shown in FIG. 10 and has been described above. The most important steps are summarized below.

During training, the multiview images captured by the motor vehicle cameras are provided to a VLLM along with a prompt specifying the task to be performed (creating a context to support the downstream task of HD map creation). In this case, too, the text and image embeddings are, for example, fused and forwarded to the LLM within the VLLM, thereby generating “global” and “token level” feature (vectors). These vectors are then processed to obtain the global language context prior. The LLM can be used here as well to obtain a textual output (text output) for verification purposes.

During training, the multiview camera images are, for example, also forwarded to a real-time vision model, the task of which is to generate a series of BEV features and an additional series of features (global context features) that should come as close as possible to the global language context prior of the VLLM. In other words, the real-time vision model is trained such that the global context features produced as output are as close as possible to those that a VLLM would generate if it were prompted to provide a useful context for HD map generation (feature matching by training). It is important that the model continues to generate a series of BEV features from the camera images, which still play an important role in map creation.

At inference time, the VLLM is no longer needed and can therefore be deactivated, since the trained real-time vision model is able to generate features that ideally correspond to the global language context prior that the VLLM would generate. The BEV and global context features are then forwarded, for example, to the map decoder, which in turn aggregates the two sources of information (for example, using cross-attention or similar mechanisms) and generates an HD map, for example, a vectorized one, as output.

It may therefore be provided, for example, for the VLLM to be used only during training, while during inference the global context feature is ascertained which is as similar as possible to the global language context prior, wherein the global context feature is generated by a (fast and lightweight) artificial neural network, for example an image encoder. This allows the method to be implemented in real time, for example, and the method can thus be carried out, for example, in real time on the vehicle side and/or efficiently implemented in a production system.

What is claimed is:

1. A method for creating a digital road map, comprising the following steps:
receiving environmental data which describe an environment of a motor vehicle;
providing the environmental data to a vision large language model including a large language model;
processing the environmental data using the vision large language model to ascertain a global language context prior about the environment;
outputting the global language context prior using the vision large language model; and
creating the digital road map based on the environmental data and based on the output global language context prior.

2. The method according to claim 1, further comprising the following steps:
providing an input to the vision large language model, wherein the input includes a question about at least one of: (i) the environment of the motor vehicle, or (ii) a task to be performed based on the environmental data;
processing the input and the environmental data using the vision large language model to output a text output corresponding to the input, wherein the processing of the input and the environmental data includes ascertaining at least one global feature and at least one token level feature using the large language model of the vision large language model, wherein the global language context prior is ascertained based on the at least one global feature and the at least one token level feature.

3. The method according to claim 2, wherein the global language context prior is checked for correctness and/or plausibility based on the text output, wherein the digital road map is created based on a result of the check for correctness and/or plausibility.

4. The method according to claim 2, wherein the vision large language model is given a global prompt indicating that the text output is to be used to create the digital road map.

5. The method according to claim 1, wherein the environmental data are processed by an artificial neural network to ascertain at least one feature of the environment, wherein the digital road map is created by a map decoder based on the at least one ascertained feature and the global language context prior.

6. The method according to claim 1, wherein at least one traffic rule and/or at least one digital SD road map and/or at least one digital pseudo-text SD road map, is provided to an embedding model for processing, wherein the digital road map is ascertained based on an output of the embedding model that is based on the processing using the embedding model.

7. A method for training an artificial neural network, comprising the following steps:
receiving environmental data which describe an environment of a motor vehicle;
providing the environmental data to a vision large language model including a large language model, and to the artificial neural network;
processing the environmental data using the vision large language model to ascertain a global language context prior about the environment;
outputting the global language context prior using the vision large language model;
wherein one epoch of the training includes the following steps:
processing the environmental data using the artificial neural network to ascertain at least one global context feature of the environment,
comparing the output global language context prior with the ascertained at least one global context feature, and
adjusting at least one weight of the artificial neural network based on the comparison.

8. The method according to claim 7, further comprising the following steps:
providing an input to the vision large language model, wherein the input includes a question about at least one of: (i) the environment of the motor vehicle, or (ii) a task to be performed based on the environmental data;
processing the input and the environmental data using the vision large language model to output a text output corresponding to the input, wherein the processing the input and the environmental data includes ascertaining at least one global feature and at least one token level feature using the large language model of the vision large language model, wherein the global language context prior is ascertained based on the at least one global feature and the at least one token level feature.

9. The method according to claim 8, wherein the global language context prior is checked for correctness and/or plausibility based on the text output, wherein the artificial neural network is trained based on a result of the check for correctness and/or plausibility.

10. The method according to claim 8, wherein the vision large language model is given a global prompt indicating that the text output is to be used to create a digital road map.

11. The method according to claim 7, wherein at least one traffic rule and/or at least one digital SD road map and/or at least one digital pseudo-text SD road map is provided to an embedding model for processing, wherein the digital road map is ascertained based on an output of the embedding model (903) that is based on the processing using the embedding model.

12. A method for creating a digital road map, comprising the following steps:
receiving environmental data which describe an environment of a motor vehicle;
providing the environmental data to an artificial neural network;
processing the environmental data using the artificial neural network to ascertain at least one global context feature of the environment and at least one feature of the environment;
outputting the ascertained at least one global context feature and the ascertained at least one feature using the artificial neural network; and
creating the digital road map based on the output at least one global context feature and the output at least one feature;
wherein the artificial neural network (1003) was trained by performing:
receiving first environmental data which describe a first environment of a first motor vehicle,
providing the first environmental data to the vision large language model including the large language model, and to the artificial neural network,
processing the first environmental data using the vision large language model to ascertain a first global language context prior about the first environment,
outputting the first global language context prior using the vision large language model,
wherein one epoch of the training includes the following steps:
processing the first environmental data using the artificial neural network to ascertain at least one first global context feature of the first environment,
comparing the output first global language context prior with the ascertained at least one first global context feature, and
adjusting at least one weight of the artificial neural network based on the comparison.

13. A device configured to create a digital road map, the device being configured to perform the following steps comprising:
receiving environmental data which describe an environment of a motor vehicle;
providing the environmental data to a vision large language model including a large language model;
processing the environmental data using the vision large language model to ascertain a global language context prior about the environment;
outputting the global language context prior using the vision large language model; and
creating the digital road map based on the environmental data and based on the output global language context prior.

14. A non-transitory machine-readable storage medium on which is stored a computer program for creating a digital road map, the computer program, when executed by a computer, causing the computer to perform the following steps comprising:
receiving environmental data which describe an environment of a motor vehicle;
providing the environmental data to a vision large language model including a large language model;
processing the environmental data using the vision large language model to ascertain a global language context prior about the environment;
outputting the global language context prior using the vision large language model; and
creating the digital road map based on the environmental data and based on the output global language context prior.
